(19) United States
(12) Patent Application Publication
(10) Pub. No.: US 2008/0178094 A1
(43) Pub. Date: Jul. 24, 2008

(54) Server-Side Peer-to-Peer (P2P) Media Streaming

(76) Inventor: Alan Ross, Rockville, MD (US)

Correspondence Address: WHITE-WELKER & WELKER, LLC, P.O. BOX 199, CLEAR SPRING, MD, 21722-0199, US

(21) Appl. No.: 11/953,831

(22) Filed: Dec. 10, 2007

Related U.S. Application Data
(60) Provisional application No. 60/885,625, filed on Jan. 19, 2007.

(51) Int. Cl. G06F 15/16; G06F 3/048

(52) U.S. Cl. 715/741; 709/203

(57) ABSTRACT

The present invention is a method and system of exchanging data between client computers and a server in a P2P network, wherein the server acts as a client in a pure P2P network and client computers exchange data from the servers. Further, the present invention uses thin client software installed at the client computers and it contacts the server to either download data or get a streaming media file. The present invention provides a reduction in complexity for a client computer in a Peer-to-Peer network system through reduced functionality and load at the client computer.

### CROSS REFERENCE TO RELATED APPLICATIONS

This application claims priority from U.S. Provisional Patent Application Ser. No. 60/885,625 entitled “Server-Side Peer-to-Peer (P2P) Media Streaming” filed on Jan. 19, 2007.

### FEDERALLY SPONSORED RESEARCH

Not Applicable

### SEQUENCE LISTING OR PROGRAM

Not Applicable

### TECHNICAL FIELD OF THE INVENTION

The present invention relates generally to software and method for server-side peer-to-peer (P2P) media streaming. More specifically, the present invention relates to software, architecture, and methods for server-side peer-to-peer (P2P) media streaming.

### DEFINITION OF KEY TERMS

“P2P technology” is a way to exchange files between users on the Internet, without a central server to manage the exchange. Some P2P systems require limited use of a server to govern the system, while others do not. But the main focus is that file exchange is conducted between the end users' computers.

“Media streaming” refers to any downloading system for media (video, audio) that allows the receiver to view the file as it is downloaded, rather than waiting for the entire file to download before playback begins.

“Fat client” software is any software where the majority of the storage and processing occurs on the client computer.

“Thin client” software is any software where the majority of the storage and processing occurs on a server, and the client is merely a user interface for software on the server. These two types of software comprise the two ends of a theoretical continuum. However, most software falls somewhere between the two. For the purposes of this document, thin client software falls further towards the thin client side of the continuum and fat client software falls further towards the opposite side.

“Malware protection software” is any software that attempts to protect end-user systems by identifying and/or disabling software created with bad intent (malware). Common categories of malware include virus protection, patch management, and spyware protection.

“internet” refers to any multi-user network.

“The Internet” or “Internet” refers to the multi-user network also know as the world wide web (WWW).

“An Internet service provider” (ISP) provides Internet access to an end user or hosting facility.

“BitTorrent” is the name of a particular implementation of the concept of chopping up a file into a plurality of pieces and then using P2P to distribute them to a user. P2P and Bittorrent technologies already exist and it is understand by those of ordinary skill in the art that P2P that BitTorrent is a subcategory of P2P file sharing technology.

### BACKGROUND OF THE INVENTION

One problem with P2P is that it requires the end user to install fat client software on their computer. Fat client software is more likely to have problems installing and/or running, due to conflicts with the operating system, other software, firewalls and/or malware software.

Another problem with P2P is that they encourage users to upload while they download. For everything someone downloads, someone else must be uploading. This is a problem for many end users, as many consumer-oriented ISPs do not allow fast upload speed.

Several P2P systems are known and taught in the prior art. For example US Patent Publication 2006/0039356, for a System and method for facilitating a peer-to-peer route via a gateway, teaches remote access architecture for providing peer-to-peer communications and remote access connectivity. This system does not teach or suggest the use of a server to store data from a peer-to-peer network, the use of a server to stream data to a client computer in a peer-to-peer network, nor the use of a thin client to connect to a server in a peer-to-peer network.

Another P2P system is International Patent Application Publication WO/2003/005640 for a method and apparatus for peer-to-peer services that also fails to teach the use of a server to stream data to a client computer in a peer-to-peer network and the use of a thin client to connect to a server in a peer-to-peer network.

International Patent Application Publication WO/2005/084132 also discloses a method and device for P2P File Sharing that includes identifying a peer-to-peer request and in response providing at least one address of a peer-to-peer server within a cluster that is adapted to service peer-to-peer requests. This system also teaches a cluster of peer to peer servers; and a first device adapted to identify a peer to peer request and to provide at least one address of a peer to peer server within the cluster, but fails to teach or suggest the use of a server to run peer-to-peer software for exchanging data with a client computer, the use of a server to stream data to a client computer in a peer-to-peer network, and the use of a thin client to connect to a server in a peer-to-peer network.

Finally, International Patent Application Publication WO/2005/125149 teaches an improved systems and methods for networking and internetworking personal servers and associated end-user devices in a modified P2P format. The publication teaches a personal server, as part of a network of personal servers where each personal server represents a user of the network. The network is a modified P2P network in that it consists of two levels of connection between end-user devices, rather than one level of end-user devices. This system also fails to teach or suggest the use of a server to stream data to a client computer in a peer-to-peer network and the use of a thin client to connect to a server in a peer-to-peer network.

Therefore, it is an objective of the present invention to teach a P2P media streaming system that does not require the installation of fat client software to an end user computer.

It is another objective of the present invention to eliminate the needs for simultaneous uploading and downloading of files or content by an end user, which eliminates the need for a faster uploading connection and reduces bandwidth requirements.

### SUMMARY OF THE INVENTION

The present invention is a method and system for server-side peer-to-peer (P2P) media streaming. The present invention causes a server or servers to act as the client or clients, running the P2P software. The same server or another server streams the file down to the end user so that the end user does not have to wait for the whole file to download to their computer in order to start watching it. This results in the use of the server to store data from a P2P network and the use of the server to transcode the data to a format that is easier to stream to a client computer. The invention improves earlier solutions by decreasing the complexity of the process to the end user and teaching the use of a server to stream data to a client computer from a peer-to-peer network. Processing, storage, and configuration are centrally managed on the server, which is the primary advantage. Central server management allows the end user to interact with P2P networks much easier.

The primary advantage of the present invention is that it teaches a P2P media streaming system that does not require the instillation of fat client software to an end user computer.

Another advantage of the present invention is that it eliminates the need for simultaneous uploading and downloading of files or content by an end user, which eliminates the need for a faster uploading connection and reduces bandwidth requirements.

The sole disadvantage is that the server now must manage and deal with all of the issues typically associated with end users such as Firewalls, malware/spyware, and upload/download speeds.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is diagram that illustrates the basic physical layout of the P2P system of the present invention illustrating a single server embodiment with multiple thin client access to the Internet; and

FIG. 2 is a flow chart that illustrates a preferred embodiment of the system and explains the flow of information, data stores, and references;

FIG. 3 is a flow chart that illustrates a preferred embodiment of the system and explains the flow of information, data stores, and references;

FIG. 4 is a flow chart illustrating the plurality of media servers and BitTorrent trackers used by the present invention to keep large files synchronized and transcoded on the media servers for use by clients; and

FIG. 5 is a flow chart illustrating the plurality of servers, transcoding servers, and BitTorrent trackers used by the present invention to keep large files synchronized on the media servers and transcoded on the transcoding servers for use by clients.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

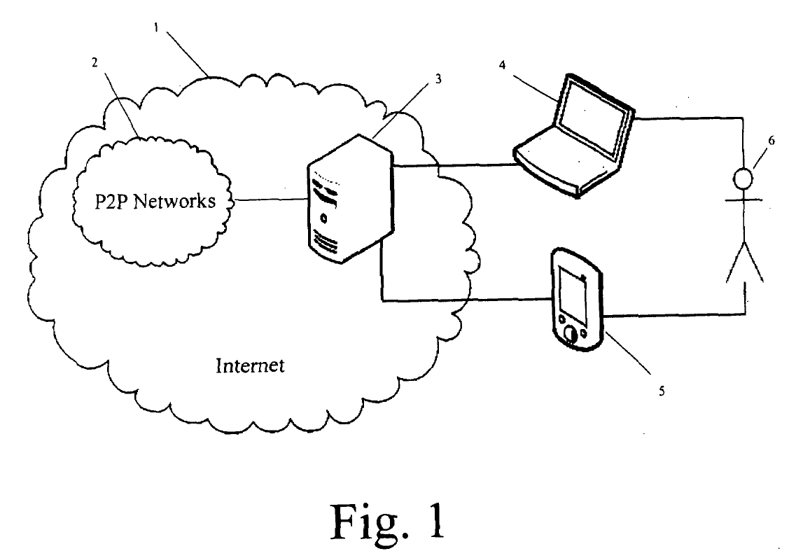

Referring to the figures, it is possible to see the various major elements constituting the present invention. The present invention is a method and system for server-side peer-to-peer (P2P) media streaming. FIG. 1 illustrates a basic physical layout of the P2P system of the present invention illustrating a single server 3 embodiment with multiple thin client access 4 & 5 to the Internet 1.

In a first embodiment of the invention a user searches for a media file on a website. The website passes the request to a module which searches the P2P network or networks 2 for a list of matching files. Next, the user is presented with a list of matching files. The user chooses one, and the request is passed to a second module that, using the P2P system, downloads the file, on the server side 3. Finally, a third module streams the file to the user 6.

In a second embodiment, the server periodically or constantly searches the P2P networks 2 for files and downloads them, so that they are readily available to be streamed by end users 6 on request.

Alternatives also include using varying number of servers 3 to accomplish the task.

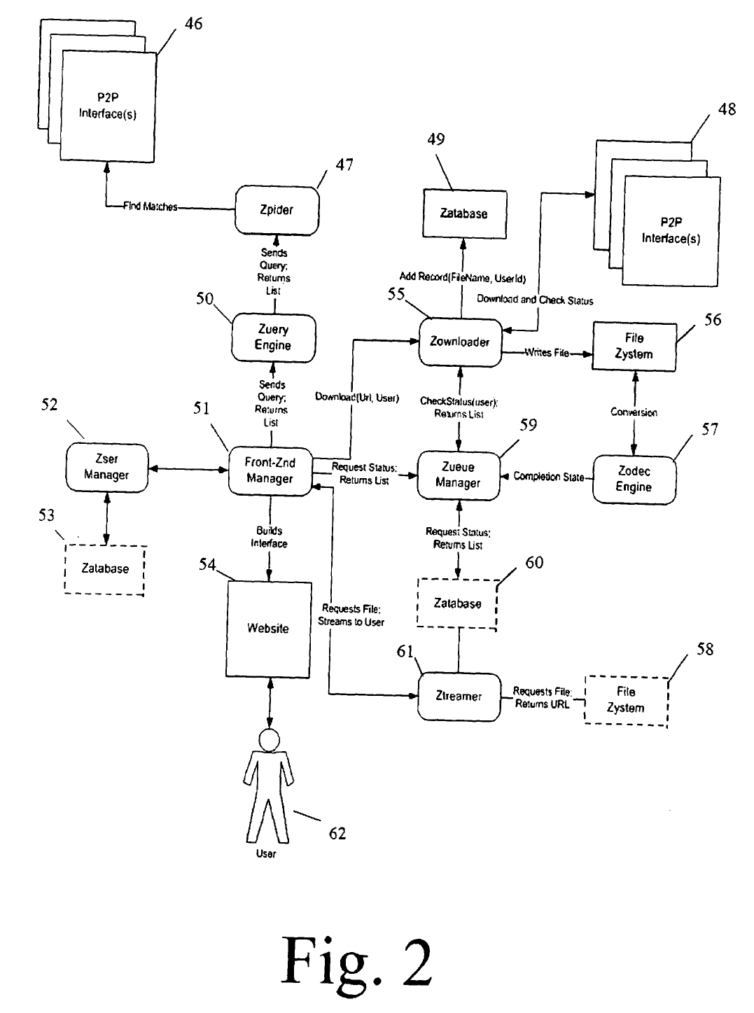

Now referring to FIG. 2, a flow chart illustrates a preferred embodiment of the system and explains the flow of information, data stores, and references. A user 62 interacts with the system via a website 54. Upon accessing the website the Front-Znd Manager 51 builds an interface for interaction with the user. The Front-Znd Manager 51 also calls other modules to send queries, return lists, download, and request status. The Zser Manager 52 handles user logins, and relationship between downloads and the user and utilizes the Zatabase 53 for storing all data necessary for the system.

The Zuery Engine 50 manages queries and preprocessing for returning results to the user and sending them to the Zpider 47. The Zpider 47 finds files and matches using the same interfaces as a fat client.

The Zueue Manager 59 manages users' pending and completed downloads while the Zownloader's 55 primary responsibility is using the P2P Interfaces 48 to download requested files to the server's Zatabase 60. Zownloader's 55 secondary responsibility is to report on downloading status and write status to database 49, as needed.

The Zodec Engine 57 performs the conversion of downloaded files to streaming media while the File Zystem 56 is a folder structure that supports storage and retrieval of all files necessary for the system. The Ztreamer 61 requests files from the file system 58 that returns the URL and then converts the files and streams the media to the user 62 upon request.

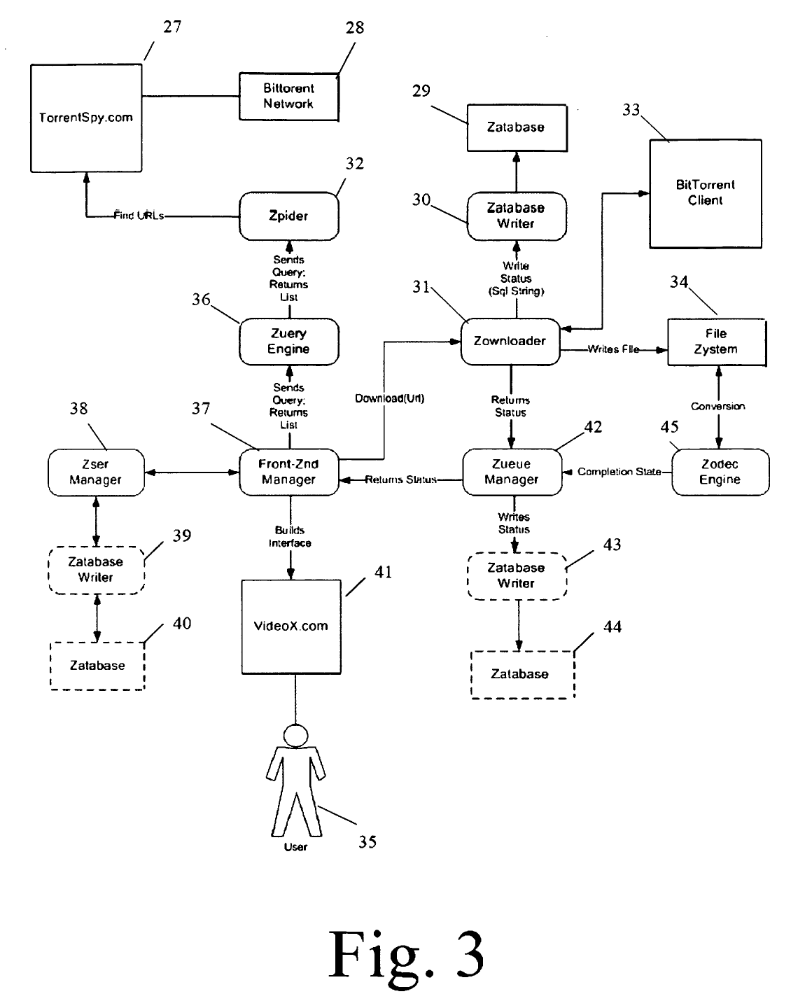

FIG. 3 is a flow chart that illustrates a preferred embodiment of the system and explains the flow of information, data stores, and references. A user 35 interacts with the system via a website 41. Upon accessing the website the Front-Znd Manager 37 builds an interface for interaction with the user. The Front-Znd Manager 37 also calls other modules to send queries, return lists, download, and request status. The Zser Manager 38 handles user logins, and relationship between downloads and the user and utilizes the a Zatabase writer 39 for storing all data necessary for the system the Zatabase 40.

The Zuery Engine 36 manages queries and preprocessing for returning results to the user and sending them to the Zpider 32. The Zpider 32 finds URLs using the and BitTorrent tracker website, one example is that of a torrentspy website, 27 connected to the BitTorrent Network 28.

The Zueue Manager 42 manages users' pending and completed downloads by receiving status updates from the Zownloader 31 and completion states from the Zodec Engine 45 while providing a return status to the Front-Znd Manager 37 and write status to the Zatabase Writer 43 and Zatabase 44. The Zownloader's 31 primary responsibility is interfacing with the BitTorrent client 33 to provide a status return to the Zueue Manager 42 and write files to the server's File Zystem 34 that provides them to the Zodec Engine 45. Zownloader's 55 secondary responsibility is to report on downloading status and write status to the server's Zatabase 29 using the Zatabase writer 30, as needed.

The Zodec Engine 45 performs the conversion of downloaded files to a completed state while the File Zystem 34 is a folder structure that supports storage and retrieval of all files necessary for the system.

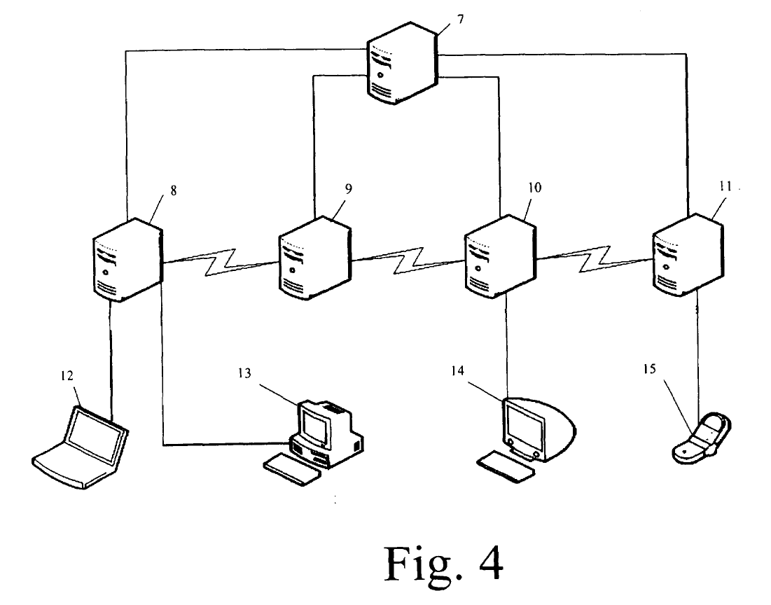

FIG. 4 is a flow chart illustrating the plurality of media servers 8, 9, 10, & 11 and BitTorrent trackers 7 used by the present invention to keep large files synchronized and transcoded on the media servers 8, 9, 10, & 11 for use by clients. A BitTorrent tracker is a server that assists in the communication between peers using the BitTorrent protocol. It is also, in the absence of extensions to the original protocol, the only major critical point, as clients are required to communicate with the tracker to initiate downloads.

Clients that have already begun downloading also communicate with the tracker periodically to negotiate with newer peers and provide statistics; however, after the initial reception of peer data, peer communication can continue without a tracker. One or more BitTorrent trackers 7 provides large files to one or more servers 8, 9, 10, & 11 that keep the large files synchronized, and transcodes them for use by clients via client devices such as laptops 12, personal computers 13, network computers 14, and mobile electronic devices 15.

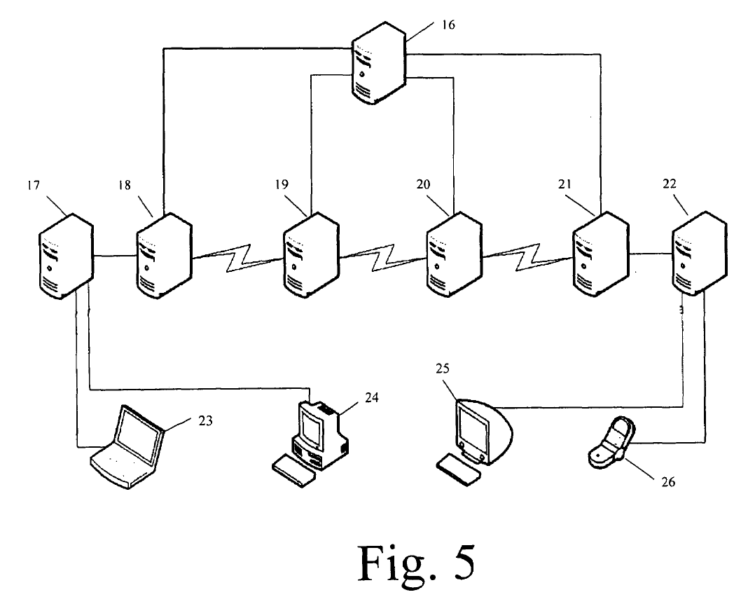

FIG. 5 is a flow chart illustrating the plurality of media servers 18, 19, 20 & 21, transcoding servers 17 & 22, and BitTorrent trackers 16 used by the present invention to keep large files synchronized on the media servers 18, 19, 20 & 21 and transcoded on the transcoding servers 17 & 22 for use by clients. One or more BitTorrent trackers 16 provides large files to one or more media servers 18, 19, 20 & 21 that keep the large files synchronized, transcoding servers 17 & 22 then transcode the large files for use by clients via client devices such as laptops 23, personal computers 24, network computers 25, and mobile electronic devices 26 that interface with the transcoding servers 17 & 22.

The present invention applies to any type of file synchronized between servers or clients, using BitTorrent, where the server transcodes the files to make them easy for clients to view/download. In alternative embodiments, the present invention could be used for video transcoding to flash, audio transcoding to a streaming protocol, or CAD files transcoding to jpg files. Additionally, the present invention can uses private or public BitTorrent trackers.

A private BitTorrent tracker is a tracker that restricts who can use it, often by requiring registration of a user account. Private BitTorrent trackers usually register how much the users upload and download and may enforce a minimum upload-to-download ratio. As a result their torrents usually offer better availability and speed compared to public trackers where leeching is more common.

Many private trackers are now implementing Passkeys in the torrent file, which gives each user a specific address to contact in order to get a list of peers. This helps to prevent unauthorized distribution of torrent files from private trackers.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. Method for file streaming comprising the steps of:
entering a user search for a file on a website on a multi-user network;
passing the website request to a first module;
searching a multi-user network by said first module for a list of matching files;
presentation to the user of a list of matching files;
selection of a file by the user;
passing the selection request to a second module;
downloading the file from peers to the server; and
streaming the file to the user via a third module.

2. The method for file streaming of claim 1 further comprising the step of providing multiple thin client access devices to access a website on a multi-user network.

3. The method for file streaming of claim 1 wherein the multi-user network is a P2P network.

4. The method for file streaming of claim 1 wherein the file is a media file.

5. The method for file streaming of claim 3 wherein one or more servers constantly searches the P2P networks for files and downloads them, so that they are readily available to be streamed by an end users on request.

6. The method for file streaming of claim 1 further comprising the steps of:
building an interface for interaction with a user;
calling other modules to send queries, return lists, download, and request status;
handling user logins, and relationship between downloads and the user and utilizes a database for storing all data;
managing queries and preprocessing for returning results to the user;
finding files and matches using the same interfaces as a fat client;
managing a users' pending and completed downloads;
reporting on downloading status and write status to one or more databases;
performing the conversion of downloaded files to streaming media and requesting files from the file system that returns a URL and then converts the files and streams the media to a user upon request.

7. The method for file streaming of claim 1 further comprising the steps of:
interaction between a user and the system via a website;
accessing the website the by building an interface for interaction with the user;
calling other modules to send queries, return lists, download, and request status;
handling user logins, and the relationship between downloads and the user and utilizing a database writer for storing all data necessary for the system the database;
managing queries and preprocessing for returning results to the user;
finding URLs using a torrent tracking website;
managing a user's pending and completed downloads by receiving status updates and completion states;
providing a return status and write status to the database;
interfacing with a BitTorrent client to provide a status return and write files to the server's file system;
reporting on downloading status and write status to the server's database; and
performing the conversion of downloaded files to a completed state.

8. The method for file streaming of claim 7 further comprising the steps of providing one or more BitTorrent trackers providing files to one or more servers that keep the files synchronized, and transcodes them for use by users via thin client access device.

9. The method for file streaming of claim 8 further comprising the steps of
providing one or more BitTorrent trackers provides files to one or more media servers;
keeping files synchronized on one or more file servers; and
transcoding the files on one or more transcoding servers for use by a user's via thin client access device.

10. The method for file streaming of claim 9 further comprising the steps of providing a private BitTorrent Tracker.

11. A system for file streaming, comprising:
a single server accessing a multi-user network;
multiple thin client access devices to said multi-user network;
means for providing a search for any type of file available on said multi-user network;
means allowing a user, on the multi-user network, to pass a requested file from a thin client access device to a first module which searches the multi-user network for a list of matching files;
means for presenting list of matching files to a user;
means for the user choosing a matching file, and passing the request to a second module that uses the multi-user network to download the requested file, on the server side; and
means for a third module to streams the requested file to the user's thin client access device.

12. The system for file streaming of claim 11 wherein multiple thin clients access a website available on the multi-user network.

13. The system for file streaming of claim 11 wherein said means provides a search for a Media file.

14. The system for file streaming of claim 11 wherein the multi-user network is a P2P network.

15. The system for file streaming of claim 14 further comprising one or more servers as means for constantly accessing the P2P networks for files, so that they are readily available to be streamed by an end users on request.

16. The system for file streaming of claim 15 further comprising:
means for building an interface for interaction with a user;
means for calling other modules to send queries, return lists, download, and request status;
means for handling user logins, and relationship between downloads and the user and utilizes a database for storing all data;
means for managing queries and preprocessing for returning results to the user;
means for finding files and matches using the same interfaces as a fat client;
means for managing a users' pending and completed downloads;
means for reporting on downloading status and write status to the database;
means for performing the conversion of downloaded files to streaming media to a folder structure that supports storage and retrieval of all files; and
means for requesting files form the file system that returns a URL and then converts the file and streams the media to a user upon request.

17. The system for file streaming of claim 15 further comprising:
means for a user to interact with the system via a website;
means for accessing the website the by building an interface for interaction with the user;
means for calling other modules to send queries, return lists, download, and request status;
means for handling user logins, and the relationship between downloads and the user and utilizing a database writer for storing all data necessary for the system the database;
means for managing queries and preprocessing for returning results to the user;
means for finding URLs using a website connected to a BitTorrent Network;
means for managing a users' pending and completed downloads by receiving status updates and completion states;
means for providing a return status and write status to the database;
means for interfacing with a BitTorrent client to provide a status return and write files to the server's file system;
means for reporting on downloading status and write status to the server's database; and
means for performing the conversion of downloaded files to a completed state.

18. The system for file streaming of claim 17 further comprising one or more BitTorrent trackers providing files to one or more servers that keep the files synchronized, and transcodes them for use by a user's via thin client access device.

19. The system for file streaming of claim 18 further comprising:
means for providing one or more BitTorrent trackers provides files to one or more media servers;
means to keep files synchronized on one or more file servers; and
means for transcoding the files on one or more transcoding servers for use by a user's via thin client access device.

20. The system for file streaming of claim 19 further comprising a private BitTorrent tracker.
